(19) United States
(12) Patent Application Publication
(10) Pub. No.: US 2007/0133952 A1
(43) Pub. Date: Jun. 14, 2007

(54) Method and system for reproducing contents

(75) Inventors: Sang-shin Park, Suwon-si (KR); Deok-ho Kim, Seoul (KR); Kang-myeong Cho, Seoul (KR); Du-il Kim, Suwon-si (KR); Yu-seong Jeon, Suwon-si (KR); Sun-il Choi, Suwon-si (KR); Hae-sik Jun, Seoul (KR); Ki-seok Chang, Suwon-si (KR); Nam-soon Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/635,595

(22) Filed: Dec. 8, 2006

(30) Foreign Application Priority Data
Dec. 8, 2005 (KR) 10-2005-0120069
Sep. 14, 2006 (KR) 10-2006-0089349

(51) Int. Cl. H04N 7/26

(52) U.S. Cl. 386/112

(57) ABSTRACT

A contents reproducing method and apparatus are provided. The method of reproducing a group of contents includes: obtaining information on a plurality of pieces of contents belonging to a group to be reproduced; reading at least a part of the contents to be reproduced and buffering the part in a decoding buffer before the contents currently being reproduced are completely reproduced based on the obtained information; and seamlessly reproducing the plurality of pieces of contents based on data of the decoding buffer.

### CROSS-REFERENCE TO RELATED PATENT APPLICATIONS

This application claims priority from Korean Patent Application Nos. 10-2005-0120069 and 10-2006-0089249, filed on Dec. 8, 2005 and Sep. 14, 2006, respectively, in the Korean Intellectual Property Office, the disclosures of which are incorporated herein by reference in their entirety.

### BACKGROUND OF THE INVENTION

1. Field of the Invention

The present invention relates to a reproduction of multimedia contents, and more particularly, to a method and apparatus for reproducing a group of contents.

2. Description of the Related Art

In a fierce competitive market of personal computers (PC), settop boxes, and home gateways, personal video recorders (PVR) occupy a home network market as a home server. The PVR is a new digital recorder that records a broadcast signal in a hard disk or a memory chip and reproduces the broadcast signal, whereas video cassette recorders (VCR) store an image signal in a magnetic tape. The PVR stores a program sent by a broadcasting station and reproduces the program, which is not different from the VCR. However, the PVR records broadcasting information in the hard disk, reproduces the broadcasting information using a file reproduction method, and like computers, includes a memory chip for storing a central processing unit (CPU), an operating system (OS), reproduction software, etc., and a hard disk for storing broadcasting contents, which is different from the VCR. Owing to the development of digital broadcasting and the PVR, the demand for digital broadcasting recording has increased. A method of effectively managing large quantities of recorded broadcasting contents is required.

FIG. 1 illustrates a method of managing the contents recorded by a conventional PVR. Referring to FIG. 1, a settop box (STB) 120 of the PVR receives electronic program guide (EPG) data and stores the EPG data in a database 130 when recording broadcasting contents. If a user selects a menu for managing or reproducing the recorded broadcasting contents, a display device 110 displays a list of the recorded broadcasting contents, i.e., a PVR list 140. Since the conventional PVR records broadcasting contents on the basis of time, a user cannot locate desired broadcasting contents when the conventional PVR records mass amounts of storage broadcasting contents. A user also cannot manage the recorded broadcasting contents, such as the deleting of recorded broadcasting contents. Also, when a series of contents are recorded and reproduced, after an installment contents are viewed, it is necessary to search for and reproduce a next installment.

When a plurality of pieces of contents are previously selected in order to be reproduced, conventionally a file is completely reproduced and then a next file is reproduced. Therefore, the reproduction of contents is stopped since a decoder is disconnected due to a change in a physical file path and then reconnected. Even when the decoder is not disconnected, the reproduction of contents is stopped until a decoding buffer is emptied and then filled with data of a next file.

### SUMMARY OF THE INVENTION

The present invention provides a method and apparatus for effectively and conveniently displaying and managing mass storage recorded broadcasting contents on a screen.

The present invention also provides a method and apparatus for the seamless reproduction of a recorded series of contents with an easy operation like watching a program.

According to an aspect of the present invention, there is provided a method of reproducing a group of contents comprising: obtaining information on a plurality of pieces of contents belonging to a group to be reproduced; reading at least a part of the contents to be reproduced and buffering the part in a decoding buffer before the contents currently being reproduced are completely reproduced based on the obtained information; and seamlessly reproducing the plurality of pieces of contents based on data of the decoding buffer.

The method may further comprise displaying a user interface for displaying reproduction information on the plurality of pieces of contents and controlling the reproduction of the plurality of pieces of contents.

The user interface may include information on reproducing time of the whole plurality of pieces of contents and a location where the contents currently being reproduced are reproduced.

The user interface may be in the form of a bar indicating the whole plurality of pieces of contents.

The user interface may include marks for identifying each of the plurality of pieces of contents.

At least a part of the plurality of pieces of contents may be received from at least one remote recording system.

According to an aspect of the present invention, there is provided an apparatus for reproducing a group of contents comprising: a file management unit which obtains information on a plurality of pieces of contents belonging to a group to be reproduced, and reads at least a part of the contents to be reproduced and buffering the part in a decoding buffer before the contents currently being reproduced are completely reproduced based on the obtained information; and a reproducing unit which seamlessly reproduces the plurality of pieces of contents based on data of the decoding buffer and displaying the contents on a display unit.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a method of managing contents recorded by a conventional personal video recorder (PVR);

FIG. 2 illustrates a method of managing recorded contents of digital broadcasting according to an exemplary embodiment of the present invention;

FIG. 3 illustrates a recording information database according to an exemplary embodiment of the present invention;

FIG. 4 illustrates a method of managing recorded contents of digital broadcasting according to another exemplary embodiment of the present invention;

FIG. 5 illustrates a recording information database according to another exemplary embodiment of the present invention;

FIG. 6 illustrates a method of managing recorded contents of digital broadcasting according to still another exemplary embodiment of the present invention;

FIG. 7 is a flowchart illustrating a method of managing recorded contents of digital broadcasting according to an exemplary embodiment of the present invention;

FIG. 8 is a block diagram of a system for managing recorded contents of digital broadcasting according to an exemplary embodiment of the present invention;

FIG. 9 is a block diagram of a contents reproducing apparatus according to an exemplary embodiment of the present invention;

FIG. 10 is a diagram for explaining a buffering principle of a file management unit according to an exemplary embodiment of the present invention;

FIG. 11 illustrates a user interface that reproduces recorded contents according to an exemplary embodiment of the present invention; and

FIG. 12 is a flowchart illustrating a contents reproduction method according to an exemplary embodiment of the present invention.

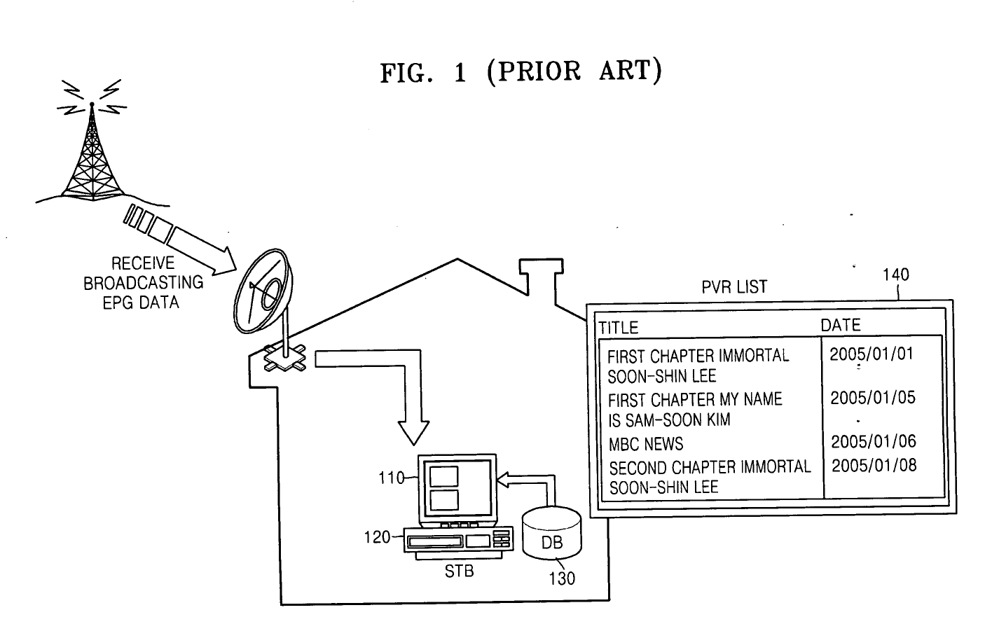

### DETAILED DESCRIPTION OF THE INVENTION

Aspects of the present invention will now be described more fully with reference to the accompanying drawings.

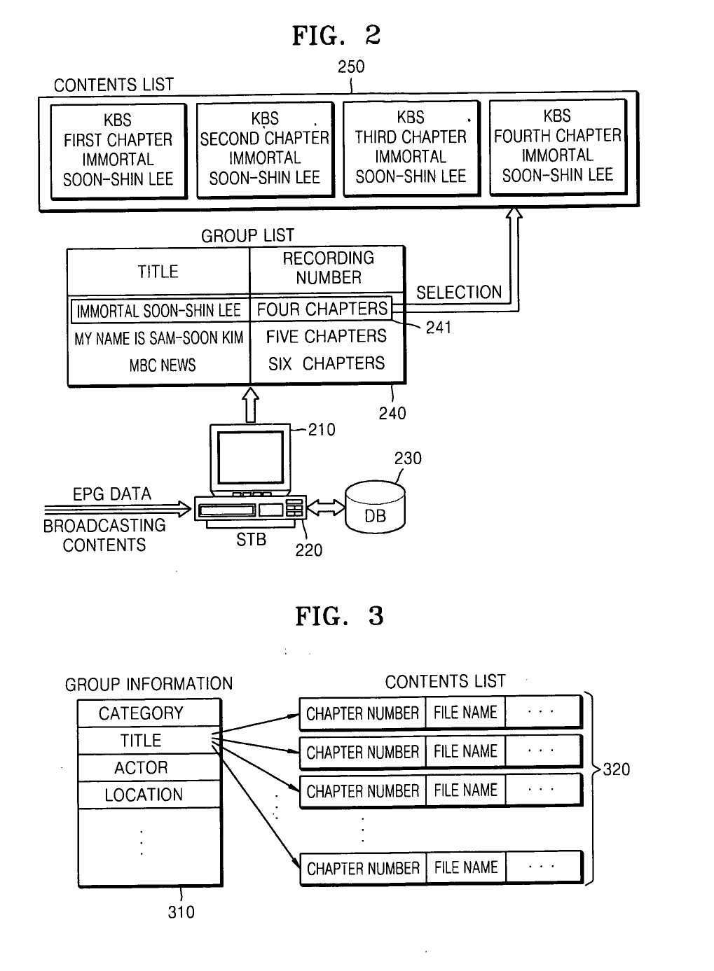

FIG. 2 illustrates a method of managing recorded contents of digital broadcasting according to an exemplary embodiment of the present invention. Referring to FIG. 2, a settop box (STB) 220 receives broadcasting contents and electronic program guide (EPG) data when recording contents of the digital broadcasting, and stores information on the recorded broadcasting contents in a recording information database 230 based on the received EPG data. The information stored in the recording information database 230 includes whole or partial EPG lists relating to the recorded broadcasting contents, and are used to manage the recorded broadcasting contents in groups.

### SUMMARY

If a user clicks a button or selects a menu to manage the recorded broadcasting contents, the entire information on the recorded broadcasting contents is not displayed on a screen. Instead, contents group information by contents is displayed on a screen. In detail, the STB 220 receives a recording information display command from the user, and displays a group list 240 that summarizes the information stored in the recording information database 230 as at least one piece of contents group information on the screen according to a predetermined standard. The predetermined standard includes information on which item is used to group the broadcasting contents. In the current exemplary embodiment of the present invention, the broadcasting contents are grouped by titles. The titles that are group identifiers and the number of broadcasting contents which are recorded in each of groups are displayed on the screen.

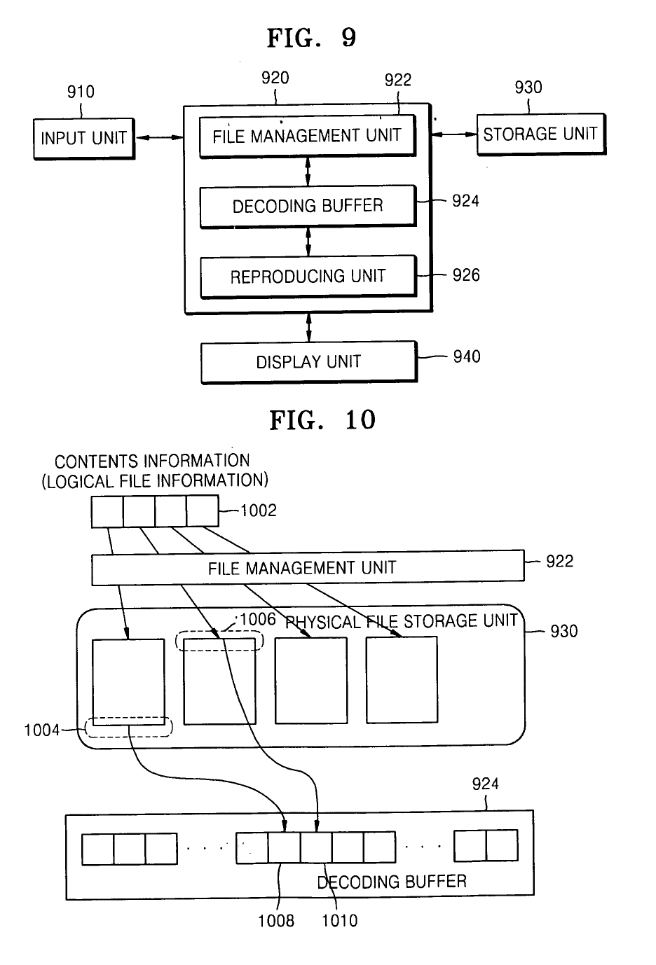

If the user selects a contents group desired to be reproduced or managed from the group list 240, a contents information list included in the selected contents group is displayed on the screen. For example, if the user selects a group “Immortal Soon-shin, Lee” 241, a contents list 250 comprised of 4 chapters included in the group 241 is displayed on the screen, and the user selects the contents desired to be reproduced from the contents list 250, and watches the recorded contents corresponding to the selected contents. When the user wants to reproduce the contents by a group unit, the contents included in the selected group 241 are continuously reproduced. A group reproduction function will be described with reference to FIGS. 9 through 12.

The user can easily perform a management operation such as deletion of contents by a group unit. If the user selects a content deletion menu from the group list 240, i.e., the STB 220 receives a command to delete a contents group from the user, the user can delete files corresponding to the contents included in the contents group using a one-time click. If the user deletes the contents from the contents list 250, files corresponding to the selected contents are deleted. The group list 240 and the contents list 250 are displayed, and the contents are reproduced and deleted, based on the content information and the contents group information stored in the recording information database 230.

FIG. 3 illustrates a recording information database according to an exemplary embodiment of the present invention. Referring to FIG. 3, the recording information database includes contents group information 310 and a content list 320 which is information on each of the contents, and groups the contents by titles of broadcasting contents. The group information 310 includes information on categories, titles, actors, and recorded parts of the broadcasting contents that are commonly applied to contents groups. The contents list 320 that groups the same titles includes information on the chapters of each of the contents, file names of the contents, recording time, etc. The recording information database can be realized using a relational database and another type of database, and can be realized in extensible markup language (XML) metadata other than the database, and is not limited to a specific technology.

When the broadcasting contents are recorded, the contents to be recorded are added to a newly created group or an existing group based on EPG data relating to the contents. For example, when a “tenth chapter of Immortal Soon-shin, LEE” is recorded, the contents group information 310 is added to the contents list 320 corresponding to an existing group “Immortal Soon-shin, LEE”. However, when a “first chapter of Lovers in Paris” is recorded, the contents group information 310 on a new group is generated, and contents information on the “Lovers in Paris” is added to the contents list 320 corresponding to the new group. A group list is displayed on a screen based on the contents group information 310. If a group is selected from the group list, the contents list 320 corresponding to the selected group is displayed on the screen.

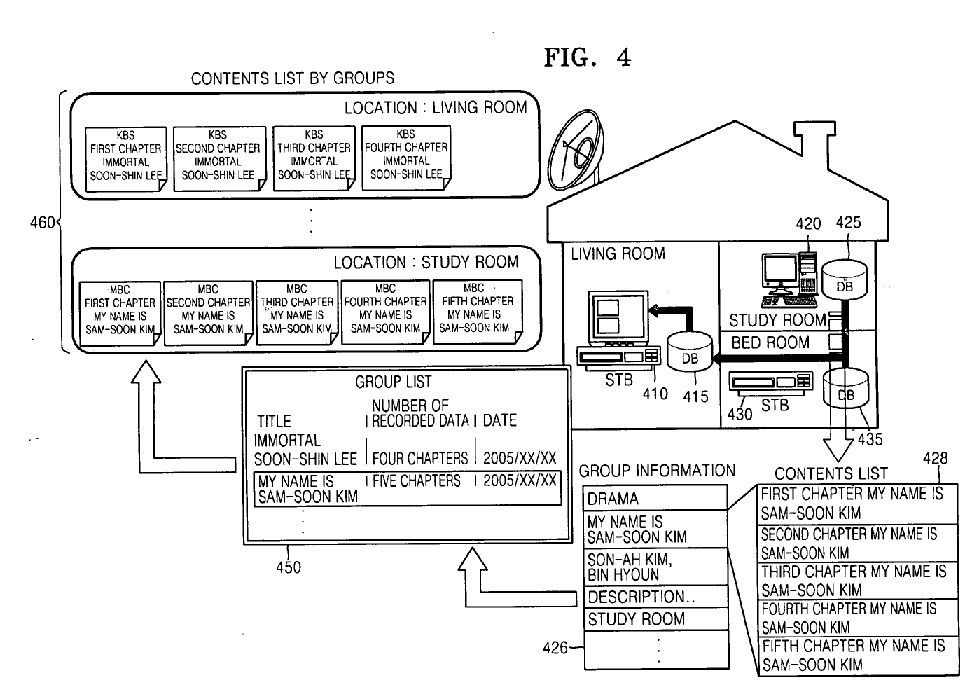

FIG. 4 illustrates a method of managing recorded contents of digital broadcasting according to another exemplary embodiment of the present invention. Referring to FIG. 4, remote contents and contents of a local recording system 410 are managed in groups based on at least one recording information database 425 and 435 of at least one remote recording systems 420 and 430 connected therebetween over a home network. If the local recording system 410 in a living room selects a recording information display menu, a screen displays a contents group “Immortal Soon-shin, LEE” stored in a local recording information database 415 and a contents group “May name is Sam-soon KIM” stored in a remote recording information database 425 in a study room. When the contents included in a group are recorded in a different recoding system, group information and contents information received from each remote recording system are combined with a local device and displayed as a group.

The local recording system 410 receives remote contents information and contents group information from the remote recording systems 420 and 430 in order to execute a selected menu. The local recording system 410 displays a group list that summarizes the information on remote contents and local contents as contents group information based on the received remote contents group information and local contents group information.

The remote recording information database includes group information 426 and a contents list 428 as illustrated in FIG. 3. If a group is selected from a group list 450 displayed on the screen, the screen displays a contents list 460 included in the selected group and thus recorded contents of the remote recording systems 420 and 430 in the study room and the bed room can be managed together.

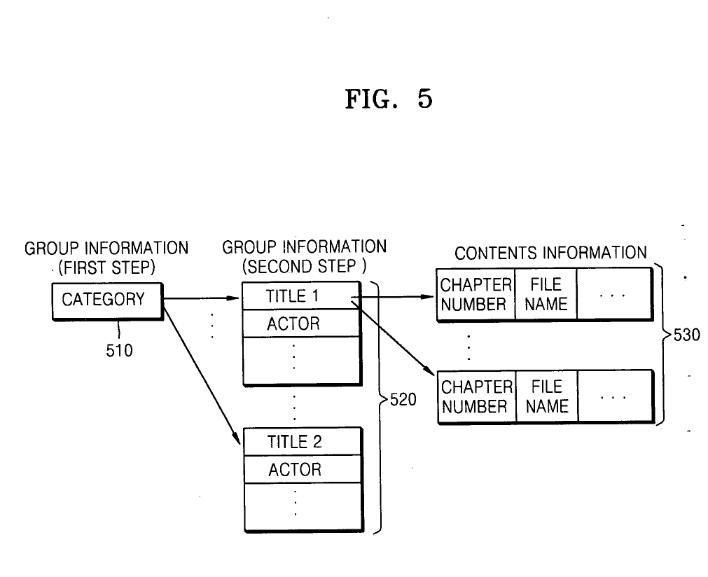

FIG. 5 illustrates a recording information database according to another exemplary embodiment of the present invention. Referring to FIG. 5, recorded contents are managed in multiple contents groups. Based on standards defining the multiple contents groups when broadcasting contents are recorded, the contents are added to one of the multiple contents groups or a newly generated contents group. A user can search for the contents of the multiple contents groups, thereby increasing user convenience, because grouping of increased number of recorded content in a single step has restrictions. For example, group information 510 that groups contents by category items such as soap operas, news, sports, etc., in a single step is created, group information 520 that groups contents by program titles is created, and a contents information list 530 is connected to the group information 510 and 520 to manage the contents.

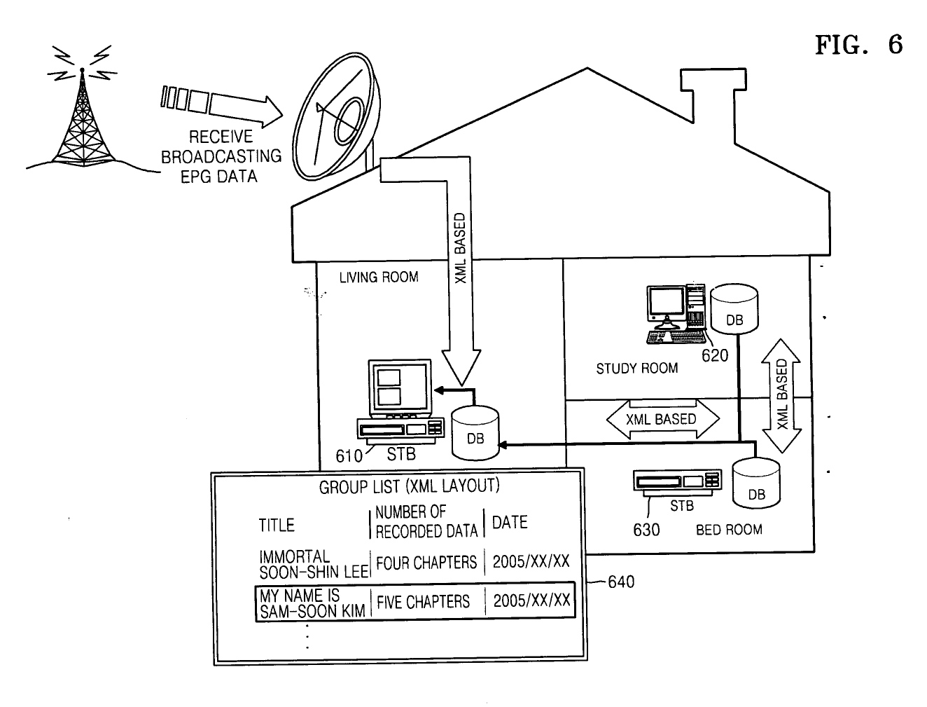

FIG. 6 illustrates a method of managing recorded contents of digital broadcasting according to still another exemplary embodiment of the present invention. Referring to FIG. 6, a user interface is realized based on an XML to display a group list 640 and a contents list. Also, a local recording system 610 and remote recording systems 620 and 630 exchange contents and group information based on the XML.

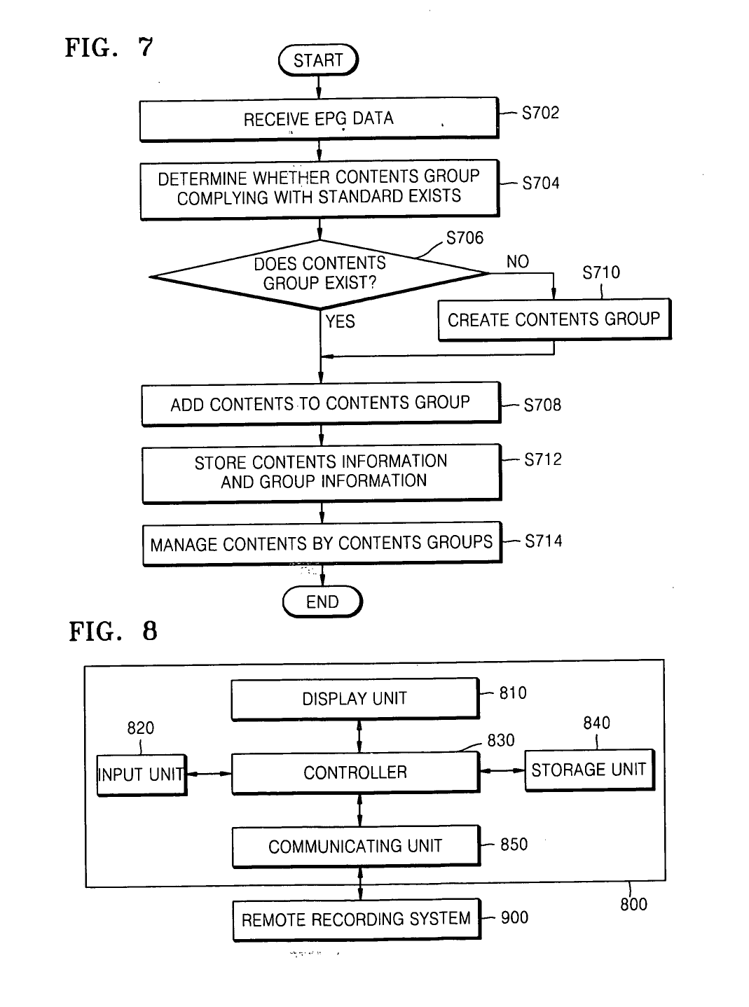

FIG. 7 is a flowchart illustrating a method of managing recorded contents of digital broadcasting according to an exemplary embodiment of the present invention. Referring to FIG. 7, EPG data relating to broadcasting contents to be recorded is received (Operation 702). It is determined whether a contents group complying with a predetermined standard exists based on the received EPG data (Operation 704). If it is determined that the contents group complying with the predetermined standard exists (Operation 706), the broadcasting content to be recorded is added to the contents group (Operation 708). If it is determined that the contents group complying with the predetermined standard does not exist (Operation 706), a new contents group is created based on the EPG data and the predetermined standard (Operation 710), and the contents are added to the created new contents group (Operation 708). Information on the recorded contents and the contents group is added to a database or updated (Operation 712). The contents are managed in groups based on the information stored in the database (Operation 714).

FIG. 8 is a block diagram of a system 800 for managing recorded contents of digital broadcasting according to an exemplary embodiment of the present invention. Referring to FIG. 8, the system 800 comprises a storage unit 840 that stores information on the recorded broadcasting contents, information on the broadcasting contents, and information on contents groups, an input unit 820 that performs a user input, a controller 830 that receives and records the digital broadcasting, a display unit 810 that displays contents controlled by the controller 830, information on the contents and the contents groups. The system 800 may comprise at least one remote recording systems 900 connected therebetween over a home network, and a communicating unit 850 that performs an XML-based communication.

The controller 830 adds the contents to a new contents group or an existing contents group complying with a predetermined standard based on the received EPG data, and manages the contents in groups according to the user input through the input unit 820. If a recording information display command is input through the input unit 820, a group list that summarizes the information on the contents as information on the contents groups is displayed on the display unit 810 based on the information stored in the storage unit 840. If a group selection command is input through the input unit 820, a contents list included in a group selected from the group list is displayed on the display unit 810. If a contents reproduction command is input through the input unit 820, the contents selected from the contents list is reproduced and displayed on the display unit 810. If a contents deletion command is input through the input unit 820, files corresponding to the contents included in the selected group are deleted from the storage unit 840 or files corresponding to the selected contents are deleted from the storage unit 840.

FIG. 9 is a block diagram of a contents reproducing apparatus according to an exemplary embodiment of the present invention. Referring to FIG. 9, the contents reproducing apparatus comprises a storage unit 930 for storing a plurality of pieces of contents and contents information including information on a group, an input unit 910 for a user input, a controller 920 for performing a reproduction function by groups, and a display unit 940 for outputting reproduced contents.

The controller 920 comprises a file management unit 922 and a reproducing unit 926 that reproduces a group of contents seamlessly, which appears the reproduction of a piece of contents. The file management unit 922, when it receives a group reproduction command through the input unit 910, reads information on the contents belonging to the group and obtains the information. The information on the contents can include information on chapters of each of the contents, file names of the contents, recording time, etc. The file management unit 922 understands the number of files to be reproduced, physical location of each file, reproducing time of each file, reproducing time of all files, etc., based on the obtained information on the contents, and manages a decoding buffer 924 to prevent its emptiness based on the understood information. The file management unit 922 reads at least a part of the contents to be reproduced next before the contents currently being reproduced are completely reproduced based on the above information, and allows the decoding buffer 924 to buffer the read part of the contents so that the reproducing unit 926 can reproduce the contents seamlessly. The reproducing unit 926 timely reproduces the data buffered in the decoding buffer 924 so that a seamlessly reproduced group of contents are displayed in the display unit 940.

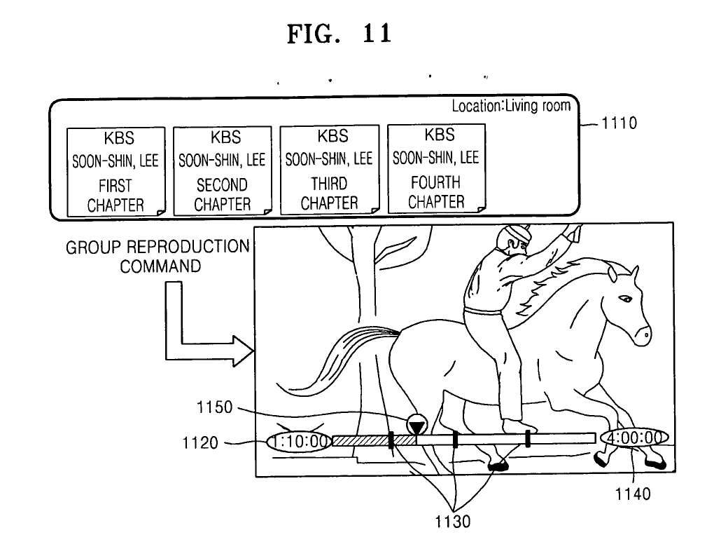

The content reproducing apparatus of the present invention can further comprise an interface processor (not shown). The interface processor generates a user interface for displaying reproduction information on the contents belonging to a group being reproduced and displays the user interface on the display unit 940 so that the user can control a group reproduction using an operation similar to the reproduction of a piece of contents. The file management unit 922 reconstitutes information relating to the reproducing time obtained from the contents information and writes the information in a memory, if necessary, confirms a part where each contents file is located in whole reproducing time based on the information relating to the reproducing time or reconstituted information, and controls the reproducing unit 926 to move a reproduction location to a specific location the user wishes. A recorded file can have an index file according to a recording method. For example, since recorded data constitutes the index file having index information on a part where an I frame is located according to the MPEG standards, it is possible to move the reproduction location to a specific location based on the index file without reconstituting reproduction time information in the file management unit 922. The user interface will be in detail described with reference to FIG. 11.

The contents reproduction apparatus of the present invention further comprises a communication unit (not shown) that communicates with at least one remote recording systems (not shown) connected through a home network, and seamlessly reproduces remote contents received through the communication unit and local contents in a group.

FIG. 10 is a diagram for explaining a buffering principle of the file management unit 922 according to an exemplary embodiment of the present invention. Referring to FIG. 10, the file management unit 922 can obtain information on a physical location of contents to be reproduced in the storage unit 930 based on file information included in contents information 1002. The file management unit 922 sequentially buffers data 1004 belonging to an end part of contents currently being reproduced and data 1006 belonging to a start part of next contents among a series of contents to be seamlessly reproduced using the decoding buffer 924. In conclusion, the reproducing unit 926 first completely reproduces the end part 1008 of the contents currently being reproduced from the decoding buffer 924 and then reads a start part 1010 of the next contents and reproduces the start part 1010.

FIG. 11 illustrates a user interface that reproduces recorded contents according to an exemplary embodiment of the present invention. Referring to FIG. 11, when a command to reproduce a group is input, contents 1110 belonging to the group, i.e., a first chapter file through a fourth chapter file of “Soon-shin, LEE”, are seamlessly reproduced like a recorded file is reproduced. Therefore, a user does not need to select a next chapter after watching a first chapter using a group-based reproduction function. Also, reproduction information is displayed on a reproduction screen like a piece of contents are reproduced. The user interface for displaying the reproduction information can include information on whole reproduction time of a plurality of pieces of contents belonging to a group and/or a location where the contents are currently being reproduced. As shown in FIG. 11, a bar type user interface is used and reproduction time of contents “Soon-shin, LEE” is an hour per chapter and the total reproduction time of four chapters is four hours 1140. A current reproduction location is a point corresponding to an hour ten minutes 1120, which can be displayed using a predetermined diagram 1150. In addition, the plurality of pieces of contents are separately displayed 1130 so that the user can be informed that a group currently being reproduced comprises recording of four chapters of contents. The user interface makes it possible to control reproduction of the contents by whole files. For example, when the user wants to see a specific location of a first chapter while watching a second chapter, the user can reproduce a desired part of another contents in the group using the user interface, like a file is reproduced.

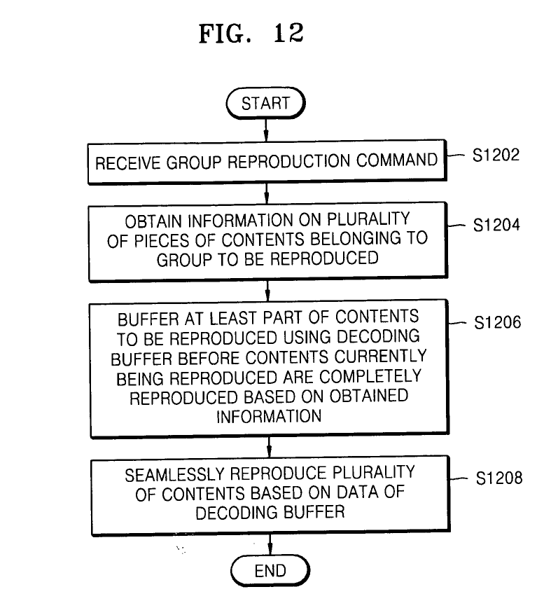

FIG. 12 is a flowchart illustrating a contents reproduction method according to an exemplary embodiment of the present invention. Referring to FIG. 12, a group reproduction command is received (Operation 1202). Information on a plurality of pieces of contents belonging to a group to be reproduced is obtained according to a received command (Operation 1204). The information on the contents of the group can be obtained based on recording information database, and can include information on chapters of each of the contents, file names of the contents, recording time, etc. The contents of the group can be partially or wholly stored in at least one remote recording systems. In this case, information on the contents of the group and the contents files can be obtained from the remote recording systems. The plurality of pieces of contents are sequentially buffered in a decoding buffer based on the obtained contents information. For the seamless reproduction, a start part of the contents to be reproduced is buffered in the decoding buffer before the contents currently being reproduced are completely reproduced (Operation 1206). As described above, the data buffered in the decoding buffer is decoded and reproduced so that the plurality of pieces of contents are seamlessly reproduced like a piece of contents (Operation 1208). A user interface for displaying reproduction information on the plurality of pieces of contents is displayed for a user. The user interface can display information on the whole reproducing time of the contents in a group to be reproduced and a location where the contents are currently reproduced. Also, a bar type user interface indicating the plurality of pieces of contents can be used but the present invention is not limited thereto. A variety of types of user interfaces can be used. A mark used to identify each piece of contents can be displayed on the user interface.

The present invention can also be embodied as computer readable code on a computer readable recording medium.

According to the present invention, the contents recorded by a local recording system and a remote recording system can be managed in groups, thereby effectively managing broadcasting contents using a mass storage PVR.

A user can seamlessly watch recorded broadcasting programs using a group-based reproduction function.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of reproducing a group of contents comprising:
obtaining information on a plurality of pieces of contents belonging to a group to be reproduced;
reading at least a part of the contents to be reproduced and buffering the part in a decoding buffer before the contents currently being reproduced are completely reproduced based on the obtained information; and
seamlessly reproducing the plurality of pieces of contents based on data of the decoding buffer.

2. The method of claim 1, further comprising displaying a user interface for displaying reproduction information on the plurality of pieces of contents and controlling the reproduction of the plurality of pieces of contents.

3. The method of claim 2, wherein the user interface includes information on reproducing time of the whole plurality of pieces of contents and a location where the contents currently being reproduced are reproduced.

4. The method of claim 2, wherein the user interface is in the form of a bar indicating the whole plurality of pieces of contents.

5. The method of claim 4, wherein the user interface includes marks for identifying each of the plurality of pieces of contents.

6. The method of claim 1, wherein at least a part of the plurality of pieces of contents is received from at least one remote recording system.

7. A computer readable medium having embodied thereon a computer program for executing a method of reproducing a group of contents, the method comprising:
obtaining information on a plurality of pieces of contents belonging to a group to be reproduced;
reading at least a part of the contents to be reproduced and buffering the part in a decoding buffer before the contents currently being reproduced are completely reproduced based on the obtained information; and
seamlessly reproducing the plurality of pieces of contents based on data of the decoding buffer.

8. An apparatus for reproducing a group of contents comprising:
a file management unit which obtains information on a plurality of pieces of contents belonging to a group to be reproduced, and reads at least a part of the contents to be reproduced and buffering the part in a decoding buffer before the contents currently being reproduced are completely reproduced based on the obtained information; and
a reproducing unit which seamlessly reproduces the plurality of pieces of contents based on data of the decoding buffer and displaying the contents on a display unit.

9. The apparatus of claim 8, further comprising an interface processor which displays a user interface for displaying reproduction information on the plurality of pieces of contents and controls the reproduction of the plurality of pieces of contents on the display unit.

10. The apparatus of claim 9, wherein the user interface includes information on reproducing time of the whole plurality of pieces of contents and a location where the contents currently being reproduced are reproduced.

11. The apparatus of claim 9, wherein the user interface is in the form of a bar indicating the whole plurality of pieces of contents.

12. The apparatus of claim 11, wherein the user interface includes marks for identifying each of the plurality of pieces of contents.

13. The apparatus of claim 8, further comprising a communication unit for communicating with at least one remote recording systems connected through a home network,
wherein at least a part of the plurality of pieces of contents is received from the at least one remote recording systems through the communication unit.
